(19) United States
(12) Patent Application Publication
(10) Pub. No.: US 2021/0224647 A1
(43) Pub. Date: Jul. 22, 2021

(54) MODEL TRAINING APPARATUS AND METHOD

(71) Applicant: NATIONAL CENTRAL UNIVERSITY, Taoyuan City (TW)

(72) Inventors: Jia-Ching WANG, Taoyuan City (TW); Ting-Yu WANG, Taoyuan City (TW)

(21) Appl. No.: 17/147,617

(22) Filed: Jan. 13, 2021

(30) Foreign Application Priority Data
Jan. 17, 2020 (TW) 109101761

(51) Int. Cl. G06N 3/08; G06N 3/04; G06K 9/62

(52) U.S. Cl. CPC G06N 3/08; G06K 9/6232; G06K 9/6257; G06N 3/0454

(57) ABSTRACT

A model training apparatus and method are provided. A neural network model includes a convolutional neural network (CNN) and a domain discriminator. The CNN includes multiple feature extractors and a classifier. The model training apparatus inputs multiple pieces of training data into the CNN so that each feature extractor generates a feature block for each piece of training data and so that the classifier generates a classification result for each piece of training data. The model training apparatus generates a vector for each piece of training data based on the corresponding feature blocks. The domain discriminator generates a domain discrimination result for each piece of training data according to the corresponding vector. The apparatus calculates a classification loss value and a domain loss value of the neural network model and determines whether to continue training the neural network model according to the classification loss value and the domain loss value.

### CROSS-REFERENCES TO RELATED APPLICATIONS

This application claims priority to Taiwan Patent Application No. 109101761, filed on Jan. 17, 2020, which is hereby incorporated by reference in its entirety.

### BACKGROUND OF THE INVENTION

### Field of the Invention

The present invention relates to a model training apparatus and method. In particular, the present invention relates to a model training apparatus and method based on adversarial transfer learning technology.

### Descriptions of the Related Art

Convolutional neural network (CNN) have achieved considerable success in many fields (e.g., image recognition), and such success relies on using a huge amount of label data as training data. Because of the high cost of obtaining label data in real scenes, the transfer learning technology has been developed. The transfer learning technology assumes that the training data and the test data are independent and identically distributed, and this purpose is to transfer knowledge from the source domain to the target domain Thus, even if the dataset of the target task has only a small amount of label data or even no label data, a CNN can be trained by using the existing label data. In this way, the cost of collecting label data can be saved. In recent years, the adversarial transfer learning technology has been developed gradually to solve the problem of domain adaptation. The adversarial transfer learning technology maximizes and minimizes the adversarial learning of CNN by using an additional domain discriminator and thereby narrow down the distance between domains and improve the versatility of CNN.

The collaborative and adversarial network (hereinafter referred to as “CAN architecture”) is an example of the adversarial transfer learning technology, which is proposed in Zhang et al.'s paper “Collaborative and adversarial network for unsupervised domain adaptation” published in “In Proceedings of the IEEE Conference on Computer Vision and Pattern Recognition” in 2018. In the CAN architecture, the shallow feature extractors of the CNN learn the domain-relevant feature and the last feature extractor of the CNN learns the domain-invariant feature by a Gradient Reversal Layer (GRL). However, the shallow feature extractors of the CAN architecture adjusts their weights by positive gradients so that the CNN becomes aware of domain features, which is difficult to achieve domain adaptation. Furthermore, in the CAN architecture, each feature extractor is provided with a corresponding domain discriminator, which enlarges the scale of the whole architecture and prolongs the training time of the CNN.

In addition to the aforesaid drawbacks, conventional adversarial transfer learning technology does not consider classification-invariant feature and nor does it consider the correlation between the shallow features. Accordingly, there is still an urgent need for an adversarial transfer learning technology that can consider domain-relevant features, domain-invariant features, classification-invariant features, and correlation between shallow features thoroughly and that does not have the aforesaid drawbacks.

### SUMMARY OF THE INVENTION

An objective of the present invention is to provide a model training apparatus. The model training apparatus comprises a storage and a processor, wherein the processor is electrically connected to the storage. The storage stores a neural network model, wherein the neural network model includes a Convolutional Neural Network (CNN) and a domain discriminator, and the CNN includes a plurality of feature extractors and a classifier. The storage further stores a plurality of first data of a first domain and a plurality of second data of a second domain, wherein a first subset of the first data and a second subset of the second data are selected as a plurality of training data.

The processor inputs the plurality of training data into the CNN so that each of the feature extractors individually generates a feature block for each of the training data and so that the classifier generates a classification result for each of the training data. The processor generates a vector for each of the training data based on the corresponding feature blocks, and the domain discriminator generates a domain discrimination result for each of the training data according to the corresponding vector. The processor further calculates a classification loss value according to a classification label and the corresponding classification result of each of the training data belonging to the first domain, calculates a domain loss value according to a domain label and the corresponding domain discrimination result of each of the training data, and determines whether to continue training the neural network model according to the classification loss value and the domain loss value.

Another objective of the present invention is to provide a model training method, which is adapted for use in an electronic computing apparatus. The electronic computing apparatus stores a neural network model, wherein the neural network model includes a CNN and a domain discriminator, and the CNN includes a plurality of feature extractors and a classifier. The electronic computing apparatus further stores a plurality of first data of a first domain and a plurality of second data of a second domain, wherein a first subset of the first data and a second subset of the second data are selected as a plurality of training data. The model training method comprises the following steps (a)-(f).

The step (a) inputs the plurality of training data into the CNN so that each of the feature extractors individually generates a feature block for each of the training data and so that the classifier generates a classification result for each of the training data. The step (b) generates a vector for each of the training data based on the corresponding feature blocks. The step (c) inputs the vectors into the domain discriminator so that the domain discriminator generates a domain discrimination result for each of the training data according to the corresponding vector. The step (d) calculates a classification loss value according to a classification label and the corresponding classification result of each of the training data belonging to the first domain. The step (e) calculates a domain loss value according to a domain label and the corresponding domain discrimination result of each of the training data. The step (f) determines whether to continue training the neural network model according to the classification loss value and the domain loss value.

A neural network model and a model training technology thereof (at least including the apparatus and the method) are provided by the present invention. The neural network model provided by the present invention includes a CNN and a domain discriminator, wherein the CNN includes a plurality of feature extractors and a classifier. The CNN is densely connected to the domain discriminator (i.e., all the feature extractors included in the CNN are connected to the domain discriminator). Based on such a structure, in addition to the conventional CNN training method, the model training technology provided by the present invention integrates the feature blocks generated by the feature extractors and then inputs the integrated result to the domain discriminator, calculates a loss value according to the output of the domain discriminator and the corresponding label, and then updates the connection weights of each of the feature extractors by the GRL. Since the domain discriminator of the neural network model is densely connected to shallow layers (i.e., the feature extractors) of the CNN, the accuracy of the transferring task (transferring from the first domain to the second domain) can be improved. Furthermore, since there is only one domain discriminator in the neural network model, only few parameters need to be trained and, hence, the training complexity is low.

According to the present invention, the domain discriminator of the neural network model may further comprise a classifier. In this way, the neural network model can keep the classification ability while learning the domain-invariant features, the classification ability of the classifier of the CNN will not be impaired, and the classification-invariant features can be learned.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1A depicts the hardware schematic view of the model training apparatus 1 according to a first embodiment to third embodiment of the present invention;

FIG. 1B depicts the schematic view of the neural network model M1;

FIG. 2 depicts the schematic view of the neural network model M2;

FIG. 3 depicts the schematic view of the neural network model M3; and

FIG. 4 depicts the main flowchart of a fourth embodiment of the present invention.

### DESCRIPTION OF THE PREFERRED EMBODIMENT

In the following description, a model training apparatus and method according to the present invention will be explained with reference to embodiments thereof. However, these embodiments are not intended to limit the present invention to any environment, applications, or implementations described in these embodiments. Therefore, description of these embodiments is only for purpose of illustration rather than to limit the scope of the present invention. It shall be appreciated that, in the following embodiments and the attached drawings, elements unrelated to the present invention are omitted from depiction; and dimensions of and dimensional relationships between individual elements in the attached drawings are provided only for illustration, but not to limit the scope of the present invention.

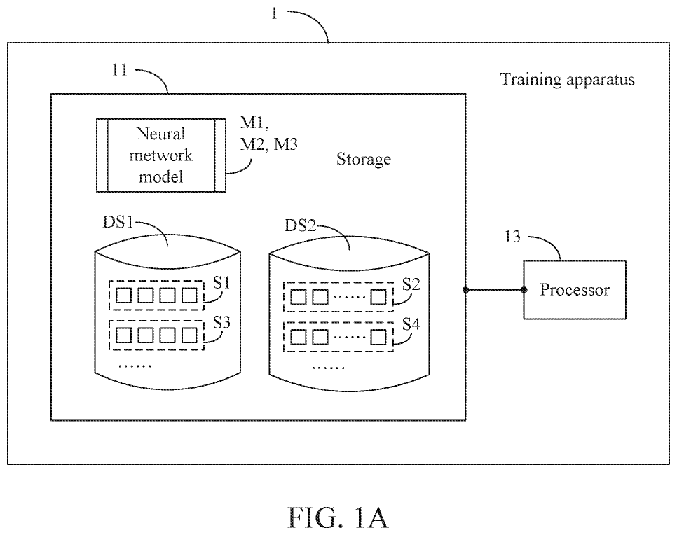

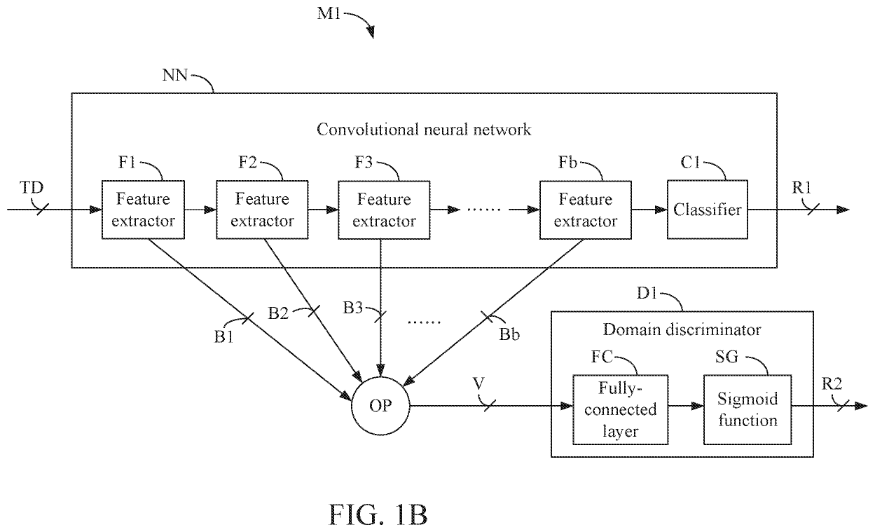

A first embodiment of the present invention is a model training apparatus 1, whose hardware schematic view is depicted in FIG. 1A. The model training apparatus 1 comprises a storage 11 and a processor 13, wherein the storage 11 is electrically connected with the processor 13. The storage 11 may be one of a memory, a hard disk drive (HDD), a universal serial bus (USB) disk, a compact disk (CD), a digital versatile disc (DVD), or any other storage media or circuits with the same function and well known to those of ordinary skill in the art. The processor 13 may be one of various processing units, a central processing unit (CPU), a microprocessor unit (MPU), a digital signal processors (DSP), or other computing apparatuses well known to those of ordinary skill in the art.

The storage 11 stores a neural network model M1, whose schematic view is depicted in FIG. 1B. The neural network model M1 comprises a convolutional neural network NN and a domain discriminator D1, wherein the convolutional neural network NN includes a plurality of feature extractors F1, F2, F3, . . . , Fb and a classifier C1. For example, the convolutional neural network NN may be one of a LeNet network, an AlexNet network, a VGG network, a GoogLeNet network, a ResNet network, but it is not limited thereto. Those of ordinary skill in the art shall be familiar with the architectures of various kinds convolutional neural networks and which layers of a convolutional neural network can be the feature extractors F1, F2, F3, . . . , Fb and the classifier C1. Thus, the details will not be described herein. The domain discriminator D1 may comprise a fully-connected layer FC and a module for performing a sigmoid function SG, and the fully-connected layers FC is connected to the module for performing the sigmoid function SG. It is noted that the domain discriminator D1 is not limited to the aforesaid structure. In this embodiment, the outputs of the feature extractors F1, F2, F3, . . . , Fb will be applied an integration process OP and then transmitted to the domain discriminator D1 (the details will be described later).

The storage 11 also stores a dataset DS1 of a first domain (not shown) and a dataset DS2 of a second domain (not shown), and the dataset DS1 and the dataset DS2 individually comprises a plurality of data. In FIG. 1A, each square in the dataset DS1 represents a piece of data, and each square in the dataset DS2 represents a piece of data as well. The type of the data depends on the application of the convolutional neural network NN in the neural network model M1. For example, if the convolutional neural network NN is for image recognition, the foregoing each piece of data is an image.

Each piece of data in the dataset DS1 has a domain label (not shown) to indicate that it belongs to the first domain, and each piece of data in the dataset DS2 has a domain label (not shown) to indicate that it belongs to the second domain. The first domain is different from the second domain. For example, the first domain and second domain may be different data sources. Each of the dataset DS1 and the dataset DS2 comprises N different classes of data, and the aforementioned variables N is a positive integer. Each piece of data in the dataset DS1 has a classification label (not shown) to indicate which class of the N classes that the piece of data belongs to. The model training apparatus 1 utilizes the dataset DS1 and the dataset DS2 to train the neural network model M1 to achieve the transfer learning task from the first domain to the second domain.

In this embodiment, the model training apparatus 1 will determine a plurality of training sets before training the neural network model M1. It shall be appreciated that the time to decide a training set is not the focus of the present invention, and the present invention does not limit the time to decide on a training set. Each training sets comprises a plurality of training data (not shown). In order to make the trained neural network model M1 be domain adaptive and achieve the transfer learning task from the first domain to the second domain, the training data included in each training set have data from the first domain as well as data from the second domain.

For comprehension, it is assumed that the subset S1 of the data included in dataset DS1 and the subset S2 of the data included in dataset DS2 are selected as a training set. In other words, each piece of data of the subset S1 is a piece of training data of the training set, and each piece of data of the subset S2 is also a piece of training data of the training set. The number of data included in the subset S1 and the number of data included in the subset S2 may be the same or different. In addition, it is assumed that the subset S3 of the data included in dataset DS1 and the subset S4 of the data included in dataset DS2 are selected as another training set. That is, each piece of data of the subset S3 is a piece of training data of the other training set, and each piece of data of the subset S4 is also a piece of training data of the other training set. Likewise, the number of data included in the subset S3 and the number of data included in the subset S4 may be the same or different.

Next, the operations performed by the model training apparatus 1 for training the neural network model M1 will be described in details. The processor 13 uses a training set to train the neural network model M1 each time and then decides whether to use another training set to train the neural network model M1 again according to the training results of that time.

An example is given herein, which utilizes the training set formed by the subset S1 and subset S2. The processor 13 inputs all the training data of the training set (i.e., all the data included in the subset S1 and all the data included in the subset S2) into the convolutional neural network NN so that each of the feature extractors F1, F2, F3, . . . , Fb individually generates a feature block for each of the training data and so that the classifier C1 generates a classification result for each of the training data. The processor 13 further generates a vector for each of the training data based on the corresponding feature blocks and input these vectors into the domain discriminator D1 so that the domain discriminator D1 generates a domain discrimination result for each of the training data according to the corresponding vector.

For comprehension, the foregoing operations will be described in details by using the piece of training data TD as an example. After the training data TD is inputted into the convolutional neural network NN, the feature extractors F1, F2, F3, . . . , Fb respectively generates the feature blocks B1, B2, B3, . . . , Bb for the training data TD and the classifier C1 generates a classification result R1 for the training data TD (i.e., the classifier C1 determines which class of the N classes does the training data TD belongs to). The processor 13 performs integration process OP on the feature blocks B1, B2, B3, . . . , Bb and thereby generate a vector V1. For example, the processor 13 may reduce the dimension of each of the feature blocks B1, B2, B3, . . . , Bb to two dimension by a 1×1 convolution kernel, perform a pooling afterwards, and then arrange the pooled two-dimensional data into a vector V1. The processor 13 then inputs the vector V1 into the domain discriminator D1 so that the domain discriminator D1 generates a domain discrimination result R2 of the training data TD (i.e., the domain discriminator D1 determines that the training data TD belongs to the first domain or the second domain).

Next, the processor 13 calculates a classification loss value (not shown) of the neural network model M1 according to the classification label and the corresponding classification result of each of the training data belonging to the first domain. For example, if the training set used in this batch of training is formed by the subset S1 and the subset S2, the processor 13 calculates the classification loss value of the neural network model M1 according to the classification label and the corresponding classification result of each data of the subset S1. In some embodiments, the aforesaid classification loss value may be a cross-entropy. It shall be appreciated that how to calculate the cross entropy based on the classification label and the corresponding classification result of each training data shall be well-known by those of ordinary skill in the art, so the details are not given herein.

Furthermore, the processor 13 calculates a domain loss value (not shown) of the neural network model M1 according to the domain label and the corresponding domain discrimination result of each of the training data. For example, if the training set used in this batch of training is formed by the subset S1 and the subset S2, the processor 13 calculates the domain loss value of the neural network model M1 according to the domain label and the corresponding domain discrimination result of each of the data of the subset S1 as well as the domain label and the corresponding domain discrimination result of each of the data of the subset S2. Similarly, in some embodiments, the aforesaid domain loss value may be a cross-entropy. It shall be appreciated that how to calculate the cross entropy based on the domain label and the corresponding domain result of each training data shall be well-known by those of ordinary skill in the art, so the details are not given herein.

Thereafter, the processor 13 determines whether to continue training the neural network model M1 according to the classification loss value and the domain loss value. If it is the first time that the processor 13 trains the neural network model M1 with a training set, the processor 13 will continue to train the neural network model M1. If it is not the first time that the processor 13 trains the neural network model M1 with a training set, the processor 13 determines whether the classification loss value has converged (i.e., considering the classification loss values derived this time and previous several times, whether the degree of fluctuation of them is less than a threshold value) and whether the domain loss value has converged (i.e., considering the domain loss values derived this time and previous several times, whether the degree of fluctuation of them is less than a threshold value). If the processor 13 determines that both the classification loss value and the domain loss value have converged, the processor 13 will stop the training of the neural network model M1 (which means that the convolutional neural network NN in the neural network model M1 is well-trained and can be used as a classification model). If the processor 13 determines that at least one of the classification loss value and the domain loss value does not converge, the processor 13 will select another training set to train the neural network model M1 again.

In some embodiments, the processor 13 may integrate the classification loss value and the domain loss value into a total loss value. For example, the processor 13 may weight the classification loss value and the domain loss value with a first weight value and a second weight value respectively and the sum up the weighted loss values as a total loss value, wherein the first weight value and the second weight value are values between integers 0 and 1. Thereafter, the processor 13 determines whether the total loss value has converged (i.e., considering the total loss values derived this time and previous several times, whether the degree of fluctuation of them is less than a threshold value). If the processor 13 determines that the total loss value has converged, the processor 13 will stop the training of the neural network model M1 (which means that the convolutional neural network NN in the neural network model M1 can be used as a classification model). If the processor 13 determines that total loss value does not converge, the processor 13 will select another training set to train the neural network model M1 again.

It is assumed that the processor 13 determines to continue training the neural network model M1. The processor 13 updates a plurality of connection weights (not shown) of each of the feature extractors F1, F2, F3, . . . , Fb, a plurality of connection weights of the classifier C1, and a plurality of connection weights of the fully-connected layers FC by a gradient descent method (not shown). It shall be appreciated that those of ordinary skill in the art should be familiar with the gradient descent method, so the details are not given herein. It is noted that the plurality of connection weights of a feature extractor are the weights of the connections between the plurality of neurons included in the feature extractor. Similarly, the plurality of connection weights of the classifier C1 are the weights of the connections between the plurality of neurons included in the classifier C1, and the plurality of connection weights of the fully-connected layer FC are the weights of the connections between the plurality of neurons included in the fully-connected layer FC.

Further, the processor 13 may update the connection weights of each of the feature extractors F1, F2, F3, . . . , Fb by the following operations: calculating a first gradient value of each of the feature extractors F1, F2, F3, . . . , Fb according to the domain loss value, calculating a second gradient value of each of the feature extractors F1, F2, F3, . . . , Fb according to the classification loss value, updating each of the first gradient values by a gradient reversal layer (GRL) individually (i.e., multiplying the first gradient value of each of the feature extractors F1, F2, F3, . . . , Fb by −1), and updating the connection weights of each of the feature extractors F1, F2, F3, . . . , Fb by the corresponding first gradient value and the second gradient value. As for the connection weights of the classifier C1 and the connection weights of the fully-connected layer FC, those of ordinary skill in the art shall be familiar with the updating methods thereof and, hence, the details are not given herein.

After the processor 13 updates the connection weights of each of the feature extractors F1, F2, F3, . . . , Fb, the connection weights of the classifier C1, and the connection weights of the fully-connected layers FC, the processor 13 selects another training set to train the neural network model M1 again. Based on the aforesaid descriptions, those of ordinary skill in the art shall appreciate the operations that will be performed by the processor 13 on each of the training data of the another training set and shall appreciate that the processor 13 will calculate another classification loss value and another domain loss value of the neural network model M1 based on the results of these operations again and then use it to determine whether to continue the training of the neural network model M1.

As described previously, the processor 13 may determine whether to continue the training of the neural network model M1 by determining whether both the classification loss value and the domain loss value have converged. Alternatively, the processor 13 may integrate the classification loss value and the domain loss value into a total loss value and determines whether to continue the training of the neural network model M1 by determining whether the total loss value has converged. Please note that when the processor 13 calculates the total loss value this time, the second weight value corresponding to the domain loss value may be increased but still within the range between the integer 0 and the integer 1.

According to the above descriptions, it is learned that the neural network model M1 trained by the model training apparatus 1 has only one domain discriminator D1 and the domain discriminator D1 is densely connected with the convolutional neural network NN (i.e., all the feature extractors F1, F2, F3, . . . , Fb of the convolutional neural network NN are connected to the domain discriminator D1). Based on such a structure, the model training apparatus 1 is able to integrate the feature blocks generated by the feature extractors F1, F2, F3, . . . , Fb, input the integrated result to the domain discriminator D1, and update the connection weights of the feature extractors F1, F2, F3, . . . , Fb by the GRL. Since the domain discriminator D1 is densely connected to the shallow layers (i.e., the feature extractors F1, F2, F3, . . . , Fb) of the convolutional neural network NN, the accuracy of the transferring task from the first domain to the second domain can be improved. Moreover, since there is only one domain discriminator D1 in the neural network model M1, the number of the parameters that have to be trained is greatly reduced comparing to the conventional CAN architecture and, hence, the training complexity is low.

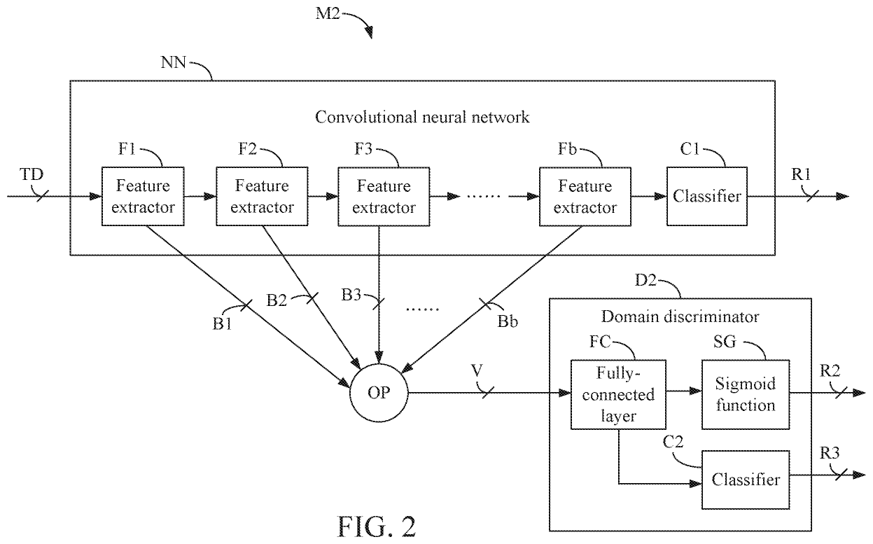

Regarding the second embodiment of the present invention, please refer to FIGS. 1A and 2. The second embodiment is similar to the first embodiment, so only the differences between the two embodiments will be described in details below.

In this embodiment, the storage 11 does not store the neural network model M1 but stores the neural network model M2 instead. FIG. 2 depicts the schematic view of the neural network model M2. The neural network model M2 includes a convolutional neural network NN and a domain discriminator D2, wherein the convolutional neural network NN is the same as that described in the first embodiment (i.e., the convolutional neural network NN comprises a plurality of feature extractors F1, F2, F3, . . . , Fb and a classifier C1). The discriminator D2 comprises a fully-connected layer FC, a module for performing a sigmoid function SG, and a classifier C2, wherein the fully-connected layer FC connects to the module for performing a sigmoid function SG and the classifier C2. It is noted that the structure of the classifier C2 is the same as that of the classifier C1.

Compared with the domain discriminator D1 of the first embodiment, the domain discriminator D2 of this embodiment further includes the classifier C2. Therefore, after the processor 13 generates a vector corresponding for each of the training data and then inputs the vectors into the domain discriminator D2, not only will the domain discriminator D2 generate a domain discrimination result for each of the training data according to the corresponding vector, but the classifier C2 will also generate another classification result for each of the training data according to the corresponding vector. Taking the aforementioned training data TD as an example, the neural network model M2 will generate a classification result R1, a domain discrimination result R2, and a classification result R3 after the processor 13 inputs the training data TD into the convolutional neural network NN.

In this embodiment, the processor 13 inputs all the training data of a training set into the convolutional neural network NN and obtains a first classification result (i.e., calculated by the classifier C1), a domain discrimination results, and a second classification results (i.e., calculated by the classifier C2) of each of the training data. Afterwards, the processor 13 calculates a domain loss value, a first classification loss value, and a second classification loss value of the neural network model M2. Specifically, the processor 13 calculates a domain loss value (not shown) of the neural network model M2 according to the domain label and the corresponding domain discrimination result of each of the training data. The processor 13 calculates a first classification loss value (not shown) of the neural network model M2 according to the classification label and the corresponding first classification result (i.e. the classification result generated by the classifier C1) of each of the training data belonging to the first domain. In addition, the processor 13 further calculates a second classification loss value (not shown) of the neural network model M2 according to the classification label and the corresponding second classification result (i.e. the classification result generated by the classifier C2) of each of the training data belonging to the first domain. Similarly, in some embodiments, each of the aforesaid domain loss value, the first classification loss value, and the second classification loss value may be a cross-entropy.

In this embodiment, the processor 13 determines whether to continue training the neural network model M2 according to the domain loss value, the first classification loss value, and the second classification loss value.

If it is the first time that the processor 13 trains the neural network model M2 with a training set, the processor 13 will continue training the neural network model M2 with another training set again. If it is not the first time that the processor 13 trains the neural network model M1 with a training set, the processor 13 determines whether all of the domain loss value, the first classification loss value, and the second classification loss value have converged. If the processor 13 determines that all of the domain loss value, the first classification loss value, and the second classification loss value have converged, the processor 13 will stop training the neural network model M2 (which means that the convolutional neural network NN in the neural network model M2 can be used as a classification model). If the processor 13 determines that at least one of the domain loss value, the first classification loss value, and the second classification loss value does not converge, the processor 13 will select another training set to continue training the neural network model M2.

In some embodiment, the processor 13 may integrate the domain loss value, the first classification loss value, and the second classification loss value as a total loss value. For example, the processor 13 may weight the domain loss value, the first classification loss value, and the second classification loss value with a first weight value, a second weight value, and a third weight value respectively and then sum up the weighted loss values as the total loss value, wherein the first weight value, the second weight value, and the third weight value are values between integers 0 and 1. Thereafter, the processor 13 determines whether the total loss value has converged (i.e., considering the total loss values derived this time and previous several times, whether the degree of fluctuation of them is less than a threshold value). If the processor 13 determines that the total loss value has converged, the processor 13 will stop training the neural network model M2 (which means that the convolutional neural network NN in the neural network model M2 can be used as a classification model). If the processor 13 determines that total loss value does not converge, the processor 13 will select another training set to continue training the neural network model M2.

It is assumed that the processor 13 determines to continue training the neural network model M1 according to the domain loss value, the first classification loss value, and the second classification loss value. The processor 13 also updates a plurality of connection weights of each of the feature extractors F1, F2, F3, . . . , Fb, a plurality of connection weights of the classifier C1, and a plurality of connection weights of the fully-connected layers FC by a gradient descent method. It shall be appreciated that those of ordinary skill in the art should be familiar with the gradient descent method. Moreover, please note that the connection weights of the classifier C2 are the weights of the connections between the plurality of neurons included in the classifier C2.

Specifically, the processor 13 may update the connection weights of each of the feature extractors F1, F2, F3, . . . , Fb by the following operations: calculating a first gradient value of each of the feature extractors F1, F2, F3, . . . , Fb according to the domain loss value, calculating a second gradient value of each of the feature extractors F1, F2, F3, . . . , Fb according to the first classification loss value, calculating a third gradient value of each of the feature extractors F1, F2, F3, . . . , Fb according to the second classification loss value, updating each of the first gradient values by the GRL individually (i.e., multiplying the first gradient value of each of the feature extractors F1, F2, F3, . . . , Fb by −1), and updating the connection weights of each of the feature extractors F1, F2, F3, . . . , Fb by the corresponding first gradient value, the second gradient value, and third gradient value. As for the connection weights of the classifier C1, the connection weights of the fully-connected layer FC, and the connection weights of the classifier C2, those of ordinary skill in the art shall be familiar with the updating methods thereof and, hence, the details are not given herein.

After the processor 13 updates the connection weights of each of the feature extractors F1, F2, F3, . . . , Fb, the connection weights of the classifier C1, the connection weights of the fully-connected layers FC, and the connection weights of the classifier C2, the processor 13 selects another training set to continue training the neural network model M2. Based on the aforesaid descriptions, those of ordinary skill in the art shall appreciate the operations that will be performed by the processor 13 on each of the training data of the other training set and shall appreciate that the processor 13 will calculate another domain loss value, another first classification loss value, and another second classification loss value of the neural network model M2 and then determine whether to continue training the neural network model M2 accordingly.

As described previously, the processor 13 may determine whether to continue training the neural network model M2 by determining whether all of the domain loss value, the first classification loss value, and the second classification loss value have converged. Alternatively, the processor 13 may integrate the domain loss value, the first classification loss value, and the second classification loss value into a total loss value and determine whether to continue training the neural network model M2 by determining whether the total loss value converges. Please note that when the processor 13 calculates the total loss value, the second weight value corresponding to the domain loss value and the third weight value corresponding to the second classification loss value may be increased but still within the range between the integer 0 and the integer 1.

According to the above descriptions, it is learned that the domain discriminator D2 of the neural network model M2 described in this embodiment has an additional classifier C2 compared to the neural network model M1 of the first embodiment. Therefore, there are some more advantages in addition to those described in the first embodiment. Specifically, when the neural network model M2 learns the domain-invariant feature, the classification feature learned by the feature extractors F1, F2, F3, . . . , Fb will not be damaged due to having the classifier C2. Thus, the neural network model M2 is able to learn the class-invariant feature and domain invariant feature. The technical effect of domain adaptation is achieved through multiple task learning.

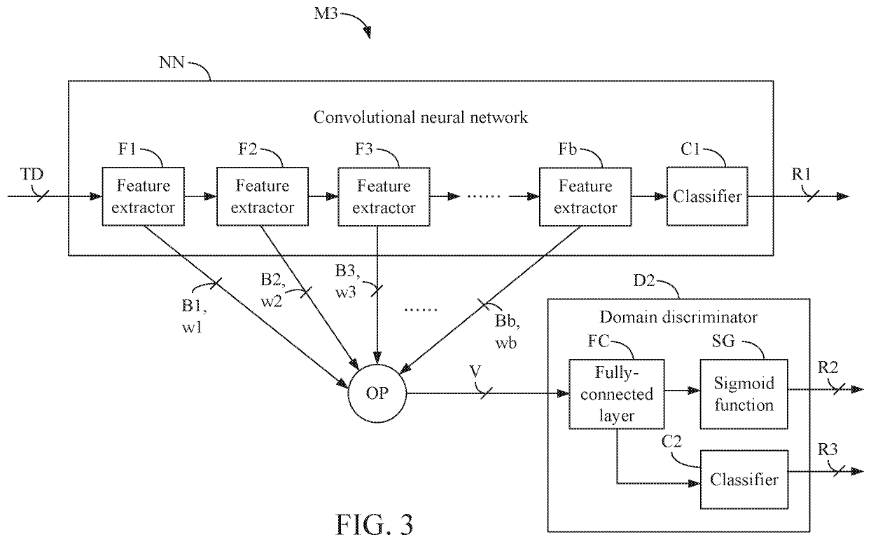

Regarding the third embodiment of the present invention, please refer to FIGS. 1A and 3. The third embodiment is similar to the second embodiment, so only the differences between the two embodiments will be described in detail below.

In this embodiment, the storage 11 does not store the neural network model M1 and M2 but stores the neural network model M3 instead. FIG. 3 depicts the schematic view of the neural network model M3. The architecture of the neural network model M3 is similar to that of the neural network model M2, but the feature extractors F1, F2, F3, . . . , Fb in the neural network model M3 correspond to the feature weights w1, w2, w3, . . . , wb respectively.

In this embodiment, since the feature extractors F1, F2, F3, . . . , Fb correspond to the feature weights w1, w2, w3, . . . , wb respectively, the processor 13 will weight each of the feature blocks by the corresponding feature weight for each of the training data and generate the vector for each of the training data based on the corresponding weighted feature blocks. Take the aforementioned training data TD as an example, the processor 13 weights the feature blocks B1, B2, B3, . . . , Bb according to the corresponding feature weights w1, w2, w3, . . . , wb respectively and generate a vector based on the weighted feature blocks.

In this embodiment, the processor 13 also determines whether to continue training the neural network model M3 according to the domain loss value, the first classification loss value, and the second classification loss value. If the processor 13 determines to continue training the neural network model M3, the processor 13 will further update the feature weights w1, w2, w3, . . . , wb according to the update value calculated based on the second classification loss value and the update value calculated based on the domain loss value and GRL in addition to updating the connection weights of each of the feature extractors F1, F2, F3, . . . , Fb, the classifiers C1, the fully-connected layer FC, and the classifier C2 in the manner described in the second embodiment. Please note that how to update the feature weights w1, w2, w3, . . . , wb, the user may adjust them based on the importance of the feature extractors F1, F2, F3, . . . , Fb in terms of the domain features and classification features (i.e., the importance to the domain discriminator D2).

Compared to the first and second embodiment, the feature extractors F1, F2, F3, . . . , Fb of the neural network model M3 in this embodiment respectively correspond to the feature weights w1, w2, w3, . . . , wb. As the characteristics of the datasets are different, the importance of these feature extractors (from the shallow layers to the deep layers) to the back-end domain discriminator are different. Thus, by having the feature extractors F1, F2, F3, . . . , Fb corresponding to the feature weights w1, w2, w3, . . . , wb respectively, the convolutional neural network NN included in the trained neural network model M3 will be more accurate in terms of classification.

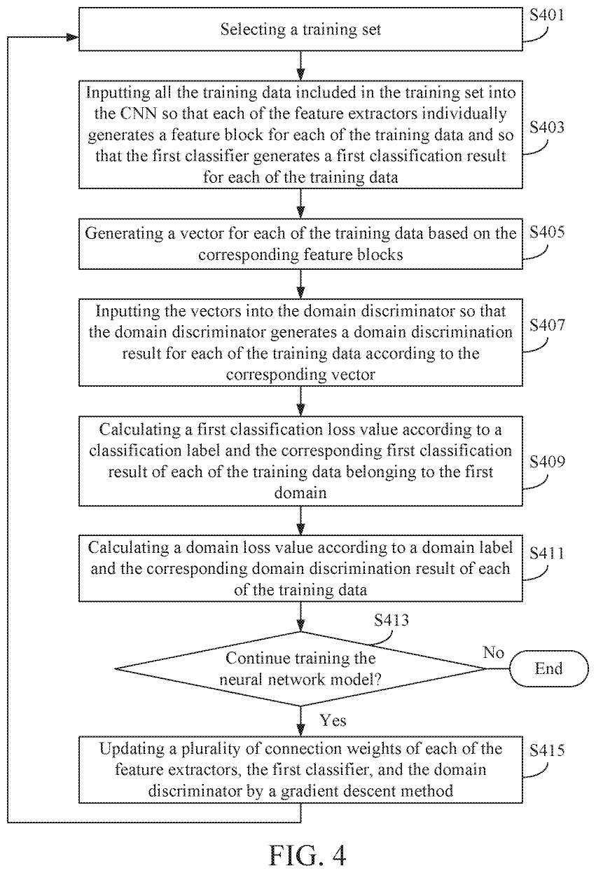

A fourth embodiment of the present invention is a model training method and a flowchart of which is depicted in FIG. 4. The model training method is suitable for use in an electronic computing apparatus, wherein the electronic computing apparatus stores a neural network model, a plurality of first data of a first domain, and a plurality of second data of a second domain. The neural network model includes a CNN and a domain discriminator. The CNN comprises a plurality of feature extractors and a first classifier. The domain discriminator comprises a fully-connected layer and a module for performing a sigmoid function, and the fully-connected layer connects to the module for performing the sigmoid function.

Specifically, in the step S401, the electronic computing apparatus selects a training set, which comprises a plurality of training data. It is noted that a subset of the aforesaid first data and a subset of the aforesaid second data form the plurality of training data. In the step S403, the electronic computing apparatus inputs all the training data included in the training set into the CNN so that each of the feature extractors individually generates a feature block for each of the training data and so that the first classifier generates a first classification result for each of the training data. In the step S405, the electronic computing apparatus generates a vector for each of the training data based on the corresponding feature blocks. In the step S407, the electronic computing apparatus inputs the vectors into the domain discriminator so that the domain discriminator generates a domain discrimination result for each of the training data according to the corresponding vector.

In the step S409, the electronic computing apparatus calculates a first classification loss value according to a classification label and the corresponding first classification result of each of the training data belonging to the first domain. In the step S411, the electronic computing apparatus calculates a domain loss value according to a domain label and the corresponding domain discrimination result of each of the training data, Please note that the present invention does not limit the execution order of the steps S409 and S411. In other words, in some embodiments, the step S409 may be executed earlier than the step S411, or the steps S409 and S411 may be executed simultaneously.

Next, in the step S413, the electronic computing apparatus determines whether to continue training the neural network model according to the first classification loss value and the first domain loss value. In particular, the step S413 determines whether to continue training the neural network model by determining whether both the domain loss value and the first classification loss value have converged. If both the domain loss value and the first classification loss value have converged, the model training method will stop training the neural network model and terminate the training procedure.

If the step S413 determines to continue training the neural network model, step S415 will be performed. In the step S415, the electronic computing apparatus updates a plurality of connection weights of each of the feature extractors, the first classifier, and the domain discriminator by a gradient descent method. In some embodiments, the step S415 calculates a first gradient value of each of the feature extractors according to the domain loss value, calculates a second gradient value of each of the feature extractors according to the first classification loss value, updates each of the first gradient values by a GRL individually (i.e., multiply by −1), and updates the connection weights of each of the feature extractors by the corresponding first gradient value and the corresponding second gradient value. After the step S415, the model training method executes the step S401 for selecting another training set to continue training the neural network model and the details are not repeated herein.

In some embodiments, the neural network model is slightly different. Specifically, the neural network model includes a CNN and a domain discriminator, wherein the CNN comprises a plurality of feature extractors and a first classifier, the domain discriminator comprises a fully-connected layer, a module for performing a sigmoid function, and a second classifier, and the fully-connected layer connects to the module for performing the sigmoid function and the second classifier.

In these embodiments, when the model training method executes the step S407, the second classifier in the domain discriminator is further configured to generate a second classification result for the training data. In these embodiments, the model training method further executes another step, in which the electronic computing apparatus calculates a second classification loss value of the neural network model according to a classification label and the corresponding second classification result of each of the training data belonging to the first domain. In these embodiments, the step S413 determines whether to continue training the neural network model by determining whether all of the domain loss value, the first classification loss value, and the second classification loss value have converged. If all of the domain loss value, the first classification loss value, and the second classification loss value have converged have converged, the model training method will stop training the neural network model and terminate the training procedure.

In some embodiments, each of the feature extractors of the convolutional neural network included in the neural network model corresponds to a feature weights individually. In these embodiments, the step S405 generates the vector for each of the first training data by weighting each of the feature blocks of each of the training data according to the corresponding feature weights and generating the vector of each of the training data based on the corresponding weighted feature blocks. Besides, in these embodiments, if the step S413 determines to continue training the neural network model, the model training method further executes another step for updating, by the electronic computing apparatus, the feature weights according to the domain loss value, the second classification loss value, and the GRL in addition to executing the step S415.

In addition to the aforesaid steps, the fourth embodiment can execute all the operations and steps of the model training apparatus 1 set forth in the first to third embodiments, have the same functions, and deliver the same technical effects as the first to third embodiments. How the fourth embodiment executes these operations and steps, has the same functions, and delivers the same technical effects as the first to third embodiments will be readily appreciated by those of ordinary skill in the art based on the explanation of the first to third embodiments. Thus, the details will not be repeated herein.

It shall be appreciated that, in the specification and the claims of the present invention, some terms (including, domain, data, classifier, subset, training data, feature block, vector, classification result, domain discrimination result, domain loss value, and classification loss value) are preceded by the terms “first,” “second,” “third,” or “fourth” and these terms “first,” “second,” “third,” and “fourth” are used only for distinguishing different terms.

According to the above descriptions, a neural network model and a model training technology thereof (at least including the apparatus and the method) are provided by the present invention. The neural network model provided by the present invention includes a CNN and a domain discriminator, wherein the CNN includes a plurality of feature extractors and a first classifier. The CNN is densely connected to the domain discriminator (i.e., all the feature extractors included in the CNN are connected to the domain discriminator). Based on such a structure, the model training technology provided by the present invention integrates the feature blocks generated by the feature extractors and then inputs the integrated result to the domain discriminator and updates the connection weights of each of the feature extractors, the classifier, and the domain discriminator by the GRL. Since the domain discriminator of the neural network model is densely connected to the shallow layers (i.e., the feature extractors) of the CNN, the accuracy of the transferring task (transferring from the first domain to the second domain) can be improved. Furthermore, since there is only one domain discriminator in the neural network model, the number of parameters that need to be trained is greatly reduced comparing to the conventional CAN architecture and, hence, the training complexity is low.

The domain discriminator of the neural network model provided by the present invention may further comprise a classifier. In this way, the neural network model can keep the classification ability while learning the domain-invariant features. The classification ability of the classifier of the CNN will not be impaired, and the classification-invariant features can be learned.

The above disclosure is only utilized to enumerate some embodiments of the present invention and illustrated technical features thereof, which is not used to limit the scope of the present invention. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A model training apparatus, comprising:
a storage, being configured to store a neural network model, a plurality of first data of a first domain, and a plurality of second data of a second domain, wherein the neural network model comprises a Convolutional Neural Network (CNN) and a domain discriminator, the CNN comprises a plurality of feature extractors and a first classifier, and a first subset of the first data and a second subset of the second data are selected as a plurality of first training data; and
a processor, being electrically connected to the storage and configured to input the first training data into the CNN so that each of the feature extractors individually generates a first feature block for each of the first training data and so that the first classifier generates a first classification result for each of the first training data,
wherein the processor generates a first vector for each of the first training data based on the corresponding first feature blocks, and the domain discriminator generates a first domain discrimination result for each of the first training data according to the corresponding first vector,
wherein the processor further calculates a first classification loss value according to a first classification label and the corresponding first classification result of each of the first training data belonging to the first domain, calculates a first domain loss value according to a first domain label and the corresponding first domain discrimination result of each of the first training data, and determines whether to continue training the neural network model according to the first classification loss value and the first domain loss value.

2. The model training apparatus of claim 1, wherein when the processor determines to continue training the neural network model according to the first domain loss value and the first classification loss value, the processor further updates a plurality of connection weights of each of the feature extractors, the first classifier, and the domain discriminator by a gradient descent method.

3. The model training apparatus of claim 2, wherein the processor updates the connection weights of each of the feature extractors by the following operations:
calculating a first gradient value of each of the feature extractors according to the first domain loss value, calculating a second gradient value of each of the feature extractors according to the first classification loss value, updating each of the first gradient values by a gradient reversal layer (GRL) individually, and updating the connection weights of each of the feature extractors by the corresponding first gradient value and the corresponding second gradient value.

4. The model training apparatus of claim 2, wherein a third subset of the first data and a fourth subset of the second data are selected as a plurality of second training data, the processor inputs the second training data into the CNN so that each of the feature extractors individually generates a second feature block for each of the second training data and so that the first classifier generates a second classification result for each of the second training data,
wherein the processor further generates a second vector for each of the second training data based on the corresponding second feature blocks, and the domain discriminator generates a second domain discrimination result for each of the second training data according to the corresponding second vector,
wherein the processor further calculates a second classification loss value according to a second classification label and the corresponding second classification result of each of the second training data belonging to the first domain, calculates a second domain loss value according to a second domain label and the corresponding second domain discrimination result of each of the second training data, and determines whether to continue training the neural network model according to the second classification loss value and the second domain loss value.

5. The model training apparatus of claim 1, wherein the domain discriminator comprises a fully-connected layer and a module for performing a sigmoid function, and the fully-connected layer connects to the module for performing the sigmoid function.

6. The model training apparatus of claim 5, wherein the domain discriminator further comprises a second classifier, the fully-connected layer further connects to the second classifier, the second classifier generates a second classification result for each of the first training data,
wherein the processor further calculates a second classification loss value according to the first classification label and the corresponding second classification result of each of the first training data belonging to the first domain, and the processor determines whether to continue training the neural network model according to the first domain loss value, the first classification loss value, and the second classification loss value.

7. The model training apparatus of claim 6, wherein a third subset of the first data and a fourth subset of the second data are selected as a plurality of second training data, and the processor further updates a plurality of connection weights of each the feature extractors, the first classifier, and the fully-connected layer by a gradient descent method when the processor determines to continue training the neural network model according to the first domain loss value, the first classification loss value, and the second classification loss value,
wherein the processor further input the second training data into the CNN so that each of the feature extractors individually generates a second feature block for each of the second training data and so that the first classifier generates a third classification result for each of the second training data,
wherein the processor further generates a second vector for each of the second training data based on the corresponding second feature blocks, and the domain discriminator further generates a second domain discrimination result and a fourth classification result for each of the second training data according to the corresponding second vector,
wherein the processor further calculates a third classification loss value according to a second classification label and the corresponding third classification result of each of the second training data belonging to the first domain, calculates a second domain loss value according to a second domain label and the corresponding second domain discrimination result of each of the second training data, calculates a fourth classification loss value according to the second classification label and the corresponding fourth classification result of each of the second training data belonging to the first domain, and determines whether to continue training the neural network model according to the third classification loss value, the fourth classification loss value, and the second domain loss value.

8. The model training apparatus of claim 6, wherein each of the feature extractors corresponds to a feature weight, and the processor generates the first vector for each of the first training data by weighting each of the first feature blocks of each of the first training data according to the corresponding feature weights and generating the first vector of each of the first training data based on the corresponding weighted first feature blocks.

9. The model training apparatus of claim 8, wherein when the processor determines to continue training the neural network model according to the first domain loss value, the first classification loss value, and the second classification loss value, the processor further updates a plurality of connection weights of each of the feature extractors, the first classifier, and the fully-connected layer by a gradient descent method, and the processor further updates the feature weights by the first domain loss value and the second classification loss value.

10. The model training apparatus of claim 9, wherein a third subset of the first data and a fourth subset of the second data are selected as a plurality of second training data, the processor further input the second training data into the CNN so that each of the feature extractors individually generates a second feature block for each of the second training data and so that the first classifier generates a third classification result for each of the second training data,
wherein the processor further generates a second vector for each of the second training data based on the corresponding second feature blocks, and the domain discriminator further generates a second domain discrimination result and a fourth classification result for each of the second training data according to each of the corresponding second vectors,
wherein the processor further calculates a third classification loss value according to a second classification label and the corresponding third classification result of each of the second training data belonging to the first domain, calculates a second domain loss value according to a second domain label and the corresponding second domain discrimination result of each of the second training data, calculates a fourth classification loss value according to the second classification label and the corresponding fourth classification result of each of the second training data belonging to the first domain, and determines whether to continue training the neural network model according to the third classification loss value, the fourth classification loss value, and the second domain loss value.

11. A model training method, being adapted for use in an electronic computing apparatus, the electronic computing apparatus storing a neural network model, a plurality of first data of a first domain, and a plurality of second data of a second domain, the neural network model comprising a Convolutional Neural Network (CNN) and a domain discriminator, the CNN comprising a plurality of feature extractors and a first classifier, a first subset of the first data and a second subset of the second data being selected as a plurality of first training data, and the model training method comprising the following steps:
(a) inputting the first training data into the CNN so that each of the feature extractors individually generates a first feature block for each of the first training data and so that the first classifier generates a first classification result for each of the first training data;
(b) generating a first vector for each of the first training data based on the corresponding first feature blocks;
(c) inputting the first vectors into the domain discriminator so that the domain discriminator generates a first domain discrimination result for each of the first training data according to the corresponding first vector;
(d) calculating a first classification loss value according to a first classification label and the corresponding first classification result of each of the first training data belonging to the first domain;
(e) calculating a first domain loss value according to a first domain label and the corresponding first domain discrimination result of each of the first training data; and
(f) determining whether to continue training the neural network model according to the first classification loss value and the first domain loss value.

12. The model training method of claim 11, further comprising the following step when the step (f) determines to continue training the neural network model:
(g) updating a plurality of connection weights of each of the feature extractors, the first classifier, and the domain discriminator by a gradient descent method.

13. The model training method of claim 12, wherein the step (g) calculates a first gradient value of each of the feature extractors according to the first domain loss value, calculates a second gradient value of each of the feature extractors according to the first classification loss value, updates each of the first gradient values by a gradient reversal layer (GRL) individually, and updates the connection weights of each of the feature extractors by the corresponding first gradient value and the corresponding second gradient value.

14. The model training method of claim 12, wherein a third subset of the first data and a fourth subset of the second data are selected as a plurality of second training data, and the model training method further comprises the following steps:
inputting the second training data into the CNN so that each of the feature extractors individually generates a second feature block for each of the second training data and so that the first classifier generates a second classification result for each of the second training data;
generating a second vector for each of the second training data based on the corresponding second feature blocks;
inputting the second vectors into the domain discriminator so that the domain discriminator generates a second domain discrimination result for each of the second training data according to the corresponding second vector;
calculating a second classification loss value according to a second classification label and the corresponding second classification result of each of the second training data belonging to the first domain;
calculating a second domain loss value according to a second domain label and the corresponding second domain discrimination result of each of the second training data; and
determining whether to continue training the neural network model according to the second classification loss value and the second domain loss value.

15. The model training method of claim 11, wherein the domain discriminator comprises a fully-connected layer and a module for performing a sigmoid function, and the fully-connected layer connects to the module for performing the sigmoid function.

16. The model training method of claim 15, wherein the domain discriminator further comprises a second classifier, the fully-connected layer further connects to the second classifier, the second classifier generates a second classification result for each of the first training data, and the model training method further comprises the following step:
calculating a second classification loss value according to the first classification label and the corresponding second classification result of each of the first training data belonging to the first domain,
wherein the step (f) determines whether to continue training the neural network model according to the first domain loss value, the first classification loss value, and the second classification loss value.

17. The model training method of claim 16, wherein a third subset of the first data and a fourth subset of the second data are selected as a plurality of second training data, and the model training method further comprises the following steps when the step (f) determines to continue training the neural network model:
updating a plurality of connection weights of each the feature extractors, the first classifier, and the fully-connected layer by a gradient descent method;
inputting the second training data into the CNN so that each of the feature extractors individually generates a second feature block for each of the second training data and so that the first classifier generates a third classification result for each of the second training data;
generating a second vector for each of the second training data based on the corresponding second feature blocks;
inputting the second vectors into the domain discriminator so that the domain discriminator generates a second domain discrimination result and a fourth classification result for each of the second training data according to the corresponding second vector;
calculating a third classification loss value according to a second classification label and the corresponding third classification result of each of the second training data belonging to the first domain;
calculating a second domain loss value according to a second domain label and the corresponding second domain discrimination result of each of the second training data;
calculating a fourth classification loss value according to the second classification label and the corresponding fourth classification result of each of the second training data belonging to the first domain; and
determining whether to continue training the neural network model according to the third classification loss value, the fourth classification loss value, and the second domain loss value.

18. The model training method of claim 16, wherein each of the feature extractors corresponds to a feature weight, and the step (b) generates the first vector for each of the first training data by weighting each of the first feature blocks of each of the first training data according to the corresponding feature weights and generating the first vector of each of the first training data based on the corresponding weighted first feature blocks.

19. The model training method of claim 18, further comprising the following steps when step (f) determines to continue training the neural network model:
updating a plurality of connection weights of each of the feature extractors, the first classifier, and the fully-connected layer by a gradient descent method; and
updating the feature weights by the first domain loss value and the second classification loss value.

20. The model training method of claim 19, wherein a third subset of the first data and a fourth subset of the second data are selected as a plurality of second training data, and the model training method further comprises the following steps:
inputting the second training data into the CNN so that each of the feature extractors individually generates a second feature block for each of the second training data and so that the first classifier generates a third classification result for each of the second training data;
generating a second vector for each of the second training data based on the corresponding second feature blocks;
inputting the second vectors into the domain discriminator so that the domain discriminator generates a second domain discrimination result and a fourth classification result for each of the second training data according to each of the second vectors;
calculating a third classification loss value according to a second classification label and the corresponding third classification result of each of the second training data belonging to the first domain;
calculating a second domain loss value according to a second domain label and the corresponding second domain discrimination result of each of the second training data;
calculating a fourth classification loss value according to the second classification label and the corresponding fourth classification result of each of the second training data belonging to the first domain; and
determining whether to continue training the neural network model according to the third classification loss value, the fourth classification loss value, and the second domain loss value.
